(19) United States
(12) Patent Application Publication
(10) Pub. No.: US 2020/0296620 A1
(43) Pub. Date: Sep. 17, 2020

(54) METHOD FOR TRANSMITTING DATA, TERMINAL DEVICE AND NETWORK DEVICE

(71) Applicant: GUANGDONG OPPO MOBILE TELECOMMUNICATIONS CORP., LTD., Dongguan, Guangdong (CN)

(72) Inventor: HAI TANG, Dongguan, Guangdong (CN)

(21) Appl. No.: 16/756,032

(22) PCT Filed: Oct. 24, 2017
(86) PCT No.: PCT/CN2017/107509

§ 371 Date: Apr. 14, 2020

(51) Int. Cl. H04W 28/02; H04W 28/06

(52) U.S. Cl. CPC H04W 28/0278; H04W 28/06

(57) ABSTRACT

Provided are a method for transmitting data, a terminal device, and a network device. The method comprises: when only one logical channel group (LCG) has data to be transmitted, determining by a terminal device a reporting format for a buffer status report (BSR) of the LCG, the reporting format being a first format or a second format, and the first format being different from the second format; and reporting by the terminal device the BSR of the LCG according to the reporting format for the BSR of the LCG. In the technical solution of the implementation of the present disclosure, when only one LCG has data to be transmitted, the terminal device can first determine the reporting format for the BSR of the LCG and then report the BSR of the LCG according to the reporting format for the BSR of the LCG.

### CROSS-REFERENCE TO RELATED APPLICATIONS

This application is a U.S. National Phase Entry of International PCT Application No. PCT/CN 2017/107509 filed on Oct. 24, 2017, the entire disclosure of which is hereby incorporated by reference.

### TECHNICAL FIELD

Implementations of the present disclosure relate to a field of communication, and more particularly, to a method for transmitting data, a terminal device, and a network device.

### BACKGROUND

A terminal device reports a Buffer Status Report (BSR) to a network device in order to let the network device know a buffer status of data to be transmitted by the terminal device, so that the network device may authorize uplink resources to the terminal device more accurately. Reporting of a BSR is controlled by a parameter coordinated with a Radio Resource Control (RRC) signaling. For example, a buffer status report period timer (periodicBSR-Timer), a buffer status report retransmission timer (retxB SR-Timer).

In addition, due to different services, a terminal device may establish a large amount of radio bearers (each bearer corresponds to a logical channel). If one BSR is reported for each logical channel, it will bring a large amount of signaling overhead. In order to avoid this situation, a concept of a Logical Channel Group (LCG) is introduced, and each logical channel is placed into one LCG. A terminal device reports a BSR based on a LCG instead of reporting one BSR for each logical channel. For example, in a Long Term Evolution (LTE) technology, the number of LCGs is 4, while in a New Air Interface (NR) technology, the number of LCGs is 8.

In LTE, when only one LCG has data to be transmitted, a terminal device adopts a short BSR format to report its buffer status. However, since a long BSR format in NR is in a form of a bitmap, when a terminal device has only one LCG with data to be transmitted, the terminal device may adopt a short BSR to report its buffer status, with only one LCG. However, in related art, no method for a terminal device to determine a reporting format of its BSR when only one LCG has data to be transmitted is related.

Therefore, in view of the situation that a terminal device has only one LCG with data to be transmitted, a method for determining a reporting format of its BSR is urgently needed to be provided in the field.

### SUMMARY

A method for transmitting data, a terminal device, and a network device are provided.

In a first aspect, a method for transmitting data is provided, including: determining, by a terminal device, a reporting format of a buffer status report (BSR) of one Logical Channel Group (LCG) when the terminal device has only the one LCG with data to be transmitted, wherein the reporting format is a first format or a second format, and the first format is different from the second format; and reporting, by the terminal device, the BSR of the one LCG according to the reporting format of the BSR of the one LCG.

According to a technical solution of an implementation of the present disclosure, when only one Logical Channel Group (LCG) has data to be transmitted, the terminal device can firstly determine the reporting format of the BSR of this one LCG, and then report the BSR of the one LCG according to the reporting format of the BSR of the one LCG.

In some possible implementations, determining the reporting format of the buffer status report (BSR) of the one LCG includes: determining, by the terminal device, the BSR of the one LCG according to a data amount of the one LCG and/or a service type corresponding to the one LCG.

In some possible implementations, before determining the reporting format of the buffer status report (BSR) of the one LCG, the method further includes: receiving, by the terminal device, indication information sent by a network device, wherein the indication information is configured for indicating that the terminal device reports the BSR of the one LCG according to the first format when the terminal device has only the one LCG with data to be transmitted, or the indication information is configured for indicating that the terminal device reports the BSR of the one LCG according to the second format when the terminal device has only the one LCG to transmit data; wherein, determining the reporting format of the buffer status report (BSR) of the one LCG includes: determining, by the terminal device, the reporting format of the BSR of the one LCG according to the indication information.

In some possible implementations, the indication information includes a threshold value, and the threshold value is configured for indicating that the terminal device reports the BSR of the one LCG according to the first format when a data amount of the data to be transmitted of the one LCG is less than or equal to the threshold value, and the terminal device reports the BSR of the one LCG according to the second format when the data amount of the data to be transmitted of the one LCG is greater than the threshold value.

In some possible implementations, the indication information includes a first service type, and the first service type is configured for indicating that the terminal device reports the BSR of the one LCG according to the first format when a service type corresponding to the one LCG is the first service type, and the terminal device reports the BSR of the one LCG according to the second format when the service type corresponding to the one LCG is not the first service type.

In some possible implementations, the number of BSRs that can be carried in the first format is different from that can be carried in the second format.

In some possible implementations, the first format is a format for reporting only the BSR of the one LCG, and the second format is a format for reporting a BSR including at least the BSR of the one LCG.

In some possible implementations, receiving, by the terminal device, the first indication information sent by the network device includes: receiving, by the terminal device, a Radio Resource Control (RRC) signaling sent by the network device, and the RRC signaling includes the indication information.

In a second aspect, a method for transmitting data is provided, including: generating, by a network device, indication information, wherein the indication information is configured for a terminal device to determine a reporting format of a buffer status report (BSR) of one Logical Channel Group (LCG) when the terminal device has only the one LCG with data to be transmitted, the reporting format is a first format or a second format, and the first format is different from the second format; and sending, by the network device, the indication information to the terminal device.

In some possible implementations, the indication information is configured for indicating that the terminal device reports the BSR of the one LCG according to the first format when the terminal device has only the one LCG with data to be transmitted, or the indication information is configured for indicating that the terminal device reports the BSR of the one LCG according to the second format when the terminal device has only the one LCG with data to be transmitted.

In some possible implementations, the indication information includes a threshold value, and the threshold value is configured for indicating that the terminal device reports the BSR of the one LCG according to the first format when a data amount of data to be transmitted of the one LCG is less than or equal to the threshold value, and the terminal device reports the BSR of the one LCG according to the second format when the data amount of the data to be transmitted of the one LCG is greater than the threshold value.

In some possible implementations, the indication information includes a first service type, and the first service type is configured for indicating that the terminal device reports the BSR of the one LCG according to the first format when a service type corresponding to the one LCG is the first service type, and the terminal device reports the BSR of the one LCG according to the second format when the service type corresponding to the one LCG is not the first service type.

In some possible implementations, the number of BSRs that can be carried in the first format is different from that can be carried in the second format.

In some possible implementations, the first format is a format for reporting only the BSR of the one LCG, and the second format is a format for reporting a BSR including at least the BSR of the one LCG.

In some possible implementations, sending, by the network device, the indication information to the terminal device includes: sending, by the network device, a Radio Resource Control (RRC) signaling to the terminal device, wherein the RRC signaling includes the indication information.

In a third aspect, a terminal device is provided, including: a processing unit, configured to determine a reporting format of a buffer status report (BSR) of one Logical Channel Group (LCG) when a terminal device has only the one LCG with data to be transmitted, wherein the reporting format is a first format or a second format, and the first format and the second format are different; and a transceiving unit, configured to report the BSR of the one LCG according to the reporting format of the BSR of the LCG.

In a fourth aspect, a terminal device is provided, including: a processor, configured to determine a reporting format of a buffer status report (BSR) of one Logical Channel Group (LCG) when a terminal device has only the one LCG with data to be transmitted, wherein the reporting format is a first format or a second format, and the first format is different from the second format; and a transceiver, configured to report the BSR of the one LCG according to the reporting format of the BSR of the one LCG.

In a fifth aspect, a network device is provided, including: a generating unit, configured to generate indication information, wherein the indication information is configured for a terminal device to determine a reporting format of a buffer status report (BSR) of one Logical Channel Group (LCG) when the terminal device has only the one LCG with data to be transmitted, the reporting format is a first format or a second format, and the first format and the second format are different; and a processing unit, configured to send the indication information to the terminal device.

In a sixth aspect, a network device is provided, including: a generator, configured to generate indication information for a terminal device to determine a reporting format of a buffer status report (BSR) of one Logical Channel Group (LCG) when the terminal device has only one LCG with data to be transmitted, wherein the reporting format is a first format or a second format, and the first format is different from the second format; and a transceiver, configured to send the indication information to the terminal device.

In a seventh aspect, a computer readable medium is provided for storing a computer program. The computer program includes instructions configured for executing the method implementations of the first aspect or the second aspect.

In an eighth aspect, a computer chip is provided. The computer chip includes an input interface, an output interface, at least one processor, and a memory. The at least one processor is configured for executing codes in the memory. When the codes are executed, the processor may implement various processes performed by the terminal device in the method for transmitting data in the first aspect and various implementations.

In a ninth aspect, a computer chip is provided. The computer chip includes an input interface, an output interface, at least one processor, and a memory. The at least one processor is configured for executing codes in the memory. When the codes are executed, the processor may implement various processes performed by the network device in the method for transmitting data in the second aspect and various implementations.

In a tenth aspect, a communication system is provided, including the above network device and the above terminal device.

### BRIEF DESCRIPTION OF DRAWINGS

FIG. 1 is an example of an application scenario of the present disclosure.

FIG. 2 is a schematic flowchart of a method for transmitting data according to an implementation of the present disclosure.

FIG. 3 is a schematic diagram of a first format of an implementation of the present disclosure.

FIG. 4 is another schematic diagram of the first format according to an implementation of the present disclosure.

FIG. 5 is a schematic diagram of a second format according to an implementation of the present disclosure.

FIG. 6 is another schematic diagram of the second format according to an implementation of the present disclosure.

FIG. 7 is a schematic block diagram of a terminal device according to an implementation of the present disclosure.

FIG. 8 is a schematic block diagram of another terminal device according to an implementation of the present disclosure.

FIG. 9 is a schematic block diagram of a network device according to an implementation of the present disclosure.

FIG. 10 is a schematic diagram of another network device according to an implementation of the present disclosure.

### DETAILED DESCRIPTION

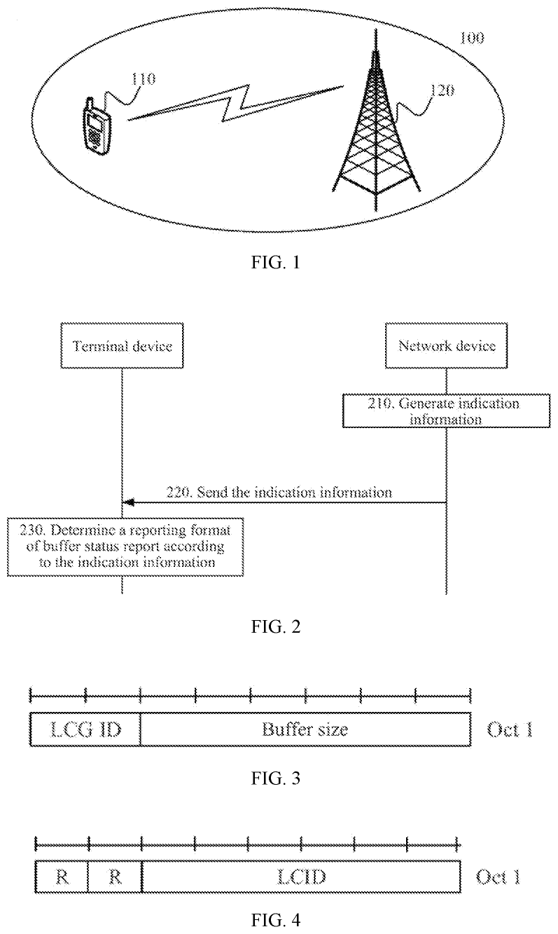

FIG. 1 is a schematic diagram of an application scenario according to an implementation of the present disclosure.

As shown in FIG. 1, a communication system 100 may include a terminal device 110 and a network device 120. The network device 120 may communicate with the terminal device 110 via an air interface. Multi-service transmission is supported between the terminal device 110 and the network device 120.

It should be understood that the communication system 100 is only an example for describing an implementation of the present disclosure. However, implementations of the present disclosure are not limited to this. For example, technical solutions of the implementations of the present disclosure may be applied to various communication systems, including but not limited to: a Global System of Mobile Communication (GSM), a Code Division Multiple Access (CDMA) system, a Wideband Code Division Multiple Access (WCDMA) system, a General Packet Radio Service (GPRS) system, a Long Term Evolution (LTE) system, a LTE Time Division Duplex (TDD) system, a Universal Mobile Telecommunication System (UMTS).

The present disclosure describes various implementations in combination with a network device and a terminal device.

The network device 120 may refer to any entity on a network side for sending or receiving signals, for example, the network device may be a user equipment of Machine Type Communication (MTC), a Base Transceiver Station (BTS) in GSM or CDMA, a NodeB in WCDMA, an Evolution Node B (eNB or NodeB) in LTE, a base station device in a 5G network.

The terminal device 110 may be any terminal device. Specifically, the terminal device 110 may communicate with one or more core networks through a radio access network (RAN), and may also be referred to as an access terminal, a User Equipment (UE), a subscriber unit, a subscriber station, a mobile station, a mobile platform, a remote station, a remote terminal, a mobile device, a user terminal, a terminal, a wireless communication device, a user agent, or a user apparatus. For example, the terminal device may be a cellular phone, a cordless phone, a Session Initiation Protocol (SIP) phone, a Wireless Local Loop (WLL) station, a Personal Digital Assistant (PDA), a handheld device with a wireless communication function, a computing device, or another processing device connected to a wireless modem, an on-board device, a wearable device, a terminal device in a 5G network.

FIG. 2 is a schematic flowchart of a method for transmitting data according to an implementation of the present disclosure.

As shown in FIG. 2, the method includes acts 210-230.

In act 210, a network device generates indication information.

In act 220, the network device sends the indication information to a terminal device.

In act 230, the terminal device determines a reporting format of a buffer status report (BSR) according to the indication information.

Specifically, when the terminal device has only one LCG with data to be transmitted, the reporting format of the BSR of the one LCG is determined, the reporting format is a first format or a second format, and the first format is different from the second format; and the terminal device reports the BSR of the one LCG according to the reporting format of the BSR of the one LCG.

It should be noted that the method for transmitting data according to an implementation of the present disclosure is applicable to a scenario where a terminal device has only one LCG with data to be transmitted. But it is not limited to this scenario.

For example, when a terminal device has multiple LCGs and the multiple LCGs have data to be transmitted, the terminal device may directly determine reporting formats of the multiple LCGs as the first format or the second format.

It should be understood that the terms first format and second format in an implementation of the present disclosure are only used for distinguishing reporting formats of BSRs from each other. Implementations of the present disclosure are not limited to specific forms thereof.

In one implementation, the number of BSRs that can be carried in the first format is different from that can be carried in the second format. Further, the first format is a format for reporting only the BSR of the one LCG, and the second format is a format for reporting a BSR including at least the BSR of the one LCG.

In order to facilitate the understanding of the solution, the following description will take the first format as a short BSR and the second format as a long BSR as an example.

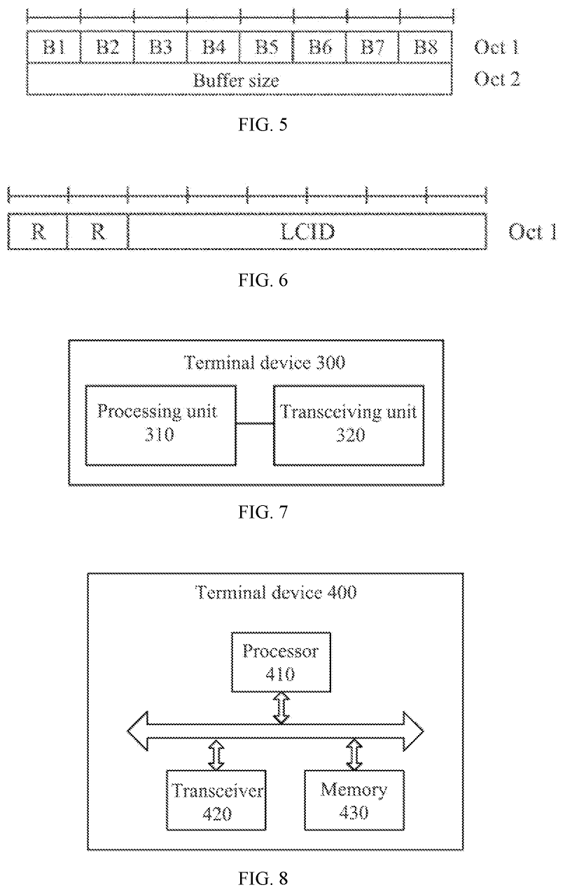

FIGS. 3 and 4 schematically show a first format in an implementation of the present disclosure, and FIGS. 5 and 6 schematically show a second format in an implementation of the present disclosure.

For example, as shown in FIG. 3, the first format may include a Logical Channel Group Identification (LCG ID) field and a corresponding Buffer Size field. It may be seen that the first format may only report a BSR of one LCG. The LCG ID field specifies a LCG corresponding to a reported buffer status, and a Buffer Size specifies a sum of available data remaining in a Radio Link Control (RLC) layer and a Packet Data Convergence Protocol (PDCP) layer corresponding to all logical channels of the LCG for transmission after all Media Access Control (MAC) Protocol Data Units (PDU) of the terminal device in a transmission time interval (TTI) for sending this BSR are generated. In addition, Oct 1 shown in FIG. 3 is a bit unit, for example, 8 bits as shown in FIG. 3.

For another example, as shown in FIG. 4, the first format may include two reserved (R) fields and one Logical Channel Group Identification (LCG ID) field. In other words, a size of data to be transmitted for all logical channels corresponding to a LCG is indicated by two R fields.

For another example, as shown in FIG. 5, the second format may include a bitmap field and a Buffer Size field. Wherein, the bitmap field indicates a reporting status of BSRs of all LGGs possessed by a terminal device, specifically B1 to B8 as shown in FIG. 5. For example, assuming a value of the bitmap field is 10000000, it may be understood that a reporting buffer status of the terminal device corresponds to only one LCG.

For another example, as shown in FIG. 6, the second format may include two reserved (R) fields and a Logical Channel Group Identification (LCG ID) field. In other words, a size of data to be transmitted for all logical channels corresponding to a LCG is indicated by two R fields. It should be understood that a difference between the first format shown in FIG. 4 and the second format shown in FIG. 6 may be that the reserved field of the first format shown in FIG. 4 may include information other than a LCG ID, while the R field shown in FIG. 6 may include a LCG ID. However, implementations of the present disclosure are not limited thereto.

It should be understood that the first format and the second format of an implementation of the present disclosure are not limited to the example descriptions of FIGS. 3 to 6. For example, as shown in FIG. 3, the LCG ID field has a field length of 3 bits, and for example, the Buffer Size field has a field length of 5 bits. However, implementations of the present disclosure are not limited thereto. For example, the LCG ID field has a field length of 2 bits, and for example, the Buffer Size field has a field length of 6 bits.

According to the technical solution of an implementation of the invention, when only one Logical Channel Group (LCG) has data to be transmitted, the terminal device can firstly determine a reporting format of a BSR of the one LCG, and then report the BSR of the one LCG according to the reporting format of the BSR of the one LCG, thereby improving a reporting efficiency of the BSR.

The following will describe an implementation that the terminal device determines the reporting format of the BSR of the one LCG when there is only one LCG has data to be transmitted in an implementation of the present disclosure.

In one implementation, the terminal device determines the BSR of the one LCG according to a data amount of the one LCG and/or a service type corresponding to the one LCG.

For example, when the data amount of the data to be transmitted of the one LCG is less than a threshold value, the terminal device may select a short BSR, if the amount of data to be transmitted of this one LCG is greater than the threshold value, the terminal device may select a long BSR.

For example, if the service type corresponding to this one LCG is a first service type, the terminal device may select a short BSR regardless of the data amount of the data to be transmitted of the one LCG; if the service type corresponding to this one LCG is other than the first service type, the terminal device may select a long BSR.

For another example, if the service type corresponding to this one LCG is the first service type, and the data amount of the data to be transmitted for this one LCG is less than a threshold value, the terminal device may select a short BSR, otherwise, the terminal device may select a long BSR.

Further, the first service type or the threshold value may be configured in advance, or may be statically or semi-statically or dynamically configured by a network device. Further, the first service type may be a type of voice service or an audio service or another service. Particular details are not limited by implementations of the present disclosure.

The threshold value and the first service type of the terminal device are preconfigured by the network device will be described as an example below. Optionally, the terminal device may receive an RRC signaling sent by the network device, and the RRC signaling includes the indication information. That is, the network device may configure the threshold value and the first service type through the RRC signaling.

Specifically, in one implementation, before the terminal device determines the reporting format of the BSR of the one LCG, the terminal device may receive indication information sent by the network device, the indication information is configured for indicating that the terminal device reports the BSR of the one LCG according to the first format when only the one LCG of the terminal device has data to be transmitted, or the indication information is configured for indicating that the terminal device reports the BSR of the one LCG according to the second format when only the one LCG of the terminal device has data to be transmitted. Therefore, the terminal device may determine the reporting format of the BSR of the one LCG according to the indication information.

For example, the indication information includes a threshold value for indicating that when a data amount of the data to be transmitted of the one LCG is less than or equal to the threshold value, the terminal device reports the BSR of the one LCG according to the first format, and when the data amount of the data to be transmitted of the one LCG is greater than the threshold value, the terminal device reports the BSR of the one LCG according to the second format.

For another example, the indication information includes a first service type, which is configured for indicating that the terminal device reports the BSR of the one LCG according to the first format when a service type corresponding to the one LCG is the first service type, and the terminal device reports the BSR of the one LCG according to the second format when the service type corresponding to the one LCG is not the first service type.

It should be understood that the above-mentioned reporting format for the network device to indicate the terminal device to determine the buffer status report is only a schematic illustration of an implementation of the present disclosure, and implementations of the present disclosure are not limited thereto.

FIG. 7 is a schematic block diagram of a terminal device according to an implementation of the present disclosure.

As shown in FIG. 7, the terminal device 300 includes a processing unit 310 and a transceiver unit 320.

The processing unit 310 is configured to determine a reporting format of the buffer status report (BSR) of one LCG when the terminal device has only one Logical Channel Group (LCG) with data to be transmitted, the reporting format is a first format or a second format, the first format is different from the second format; and the transceiver unit 320 is configured to report the BSR of the one LCG according to the reporting format of the BSR of the one LCG.

Optionally, the processing unit 310 is specifically configured to: determine the BSR of the one LGG according to a data amount of the one LCG and/or a service type corresponding to the one LCG.

Optionally, the transceiver unit 320 is further configured to: receive indication information sent by the network device before the processing unit 310 determines the reporting format of the buffer status report BSR of the one LCG, the indication information is configured for indicating that the terminal device reports the BSR of the one LCG according to the first format when the terminal device has only the one LCG with data to be transmitted, or the indication information is configured for indicating that the terminal device reports the BSR of the one LCG according to the second format when the terminal device has only the one LCG with data to be transmitted; wherein, the processing unit 310 is specifically configured to: determine the reporting format of the BSR of the one LGG according to the indication information.

Optionally, the indication information includes a threshold value for indicating that the terminal device reports the BSR of the one LCG according to the first format when a data amount of the data to be transmitted of the one LCG is less than or equal to the threshold value, and the terminal device reports the BSR of the one LCG according to the second format when the data amount of the data to be transmitted of the one LCG is greater than the threshold value.

Optionally, the indication information includes a first service type, which is configured for indicating that the terminal device reports the BSR of the one LCG according to the first format when a service type corresponding to the one LCG is the first service type, and the terminal device reports the BSR of the one LCG according to the second format when the service type corresponding to the one LCG is not the first service type.

Optionally, the number of BSRs that can be carried in the first format is different from that can be carried in the second format.

Optionally, the first format is a format for reporting only the BSR of the one LCG, and the second format is a format for reporting a BSR including at least the BSR of the one LCG.

Optionally, the transceiver unit 320 is specifically configured to: receive a Radio Resource Control (RRC) signaling sent by the network device, wherein the RRC signaling includes the indication information.

It should be noted that the processing unit 310 may be implemented by a processor, and the transceiving unit 320 may be implemented by a transceiver. As shown in FIG. 8, a terminal device 400 may include a processor 410, a transceiver 420, and a memory 430. The memory 430 may be configured for storing indication information, or may be configured for storing codes, instructions, etc., executed by the processor 410. The various components in the terminal device 400 are connected by a bus system. The bus system includes a power bus, a control bus and a status signal bus in addition to a data bus.

The terminal device 400 shown in FIG. 8 may implement the various processes implemented by the terminal device in the method implementation of FIG. 2 described above. In order to avoid duplication, the details will not be repeated here.

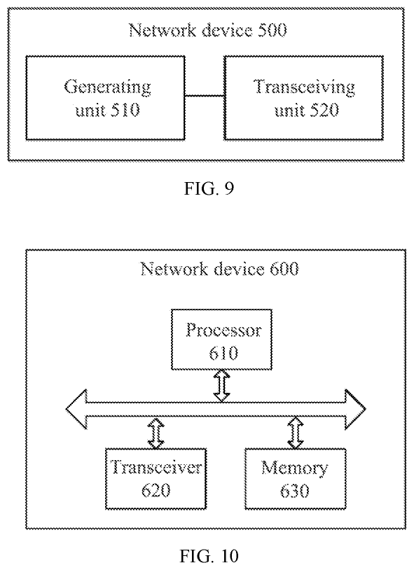

FIG. 9 is a schematic block diagram of a network device according to an implementation of the present disclosure.

As shown in FIG. 9, the network device 500 includes a generating unit 510 and a transceiving unit 520.

The generating unit 510 is configured to generate indication information for a terminal device to determine a reporting format of a buffer status report (BSR) of one Logical Channel Group (LCG) when the terminal device has only one LCG with data to be transmitted, the reporting format is a first format or a second format, the first format is different from the second format; and the transceiving unit 520, configured to send the indication information to the terminal device.

Optionally, the indication information is configured for indicating that the terminal device reports the BSR of the one LCG according to the first format when the terminal device has only the one LCG with data to be transmitted, or the indication information is configured for indicating that the terminal device reports the BSR of the one LCG according to the second format when the terminal device has only the one LCG with data to be transmitted.

Optionally, the indication information includes a threshold value for indicating that the terminal device reports the BSR of the one LCG according to the first format when a data amount of the data to be transmitted of the one LCG is less than or equal to the threshold value, and the terminal device reports the BSR of the one LCG according to the second format when the data amount of the data to be transmitted of the one LCG is greater than the threshold value.

Optionally, the indication information includes a first service type, which is configured for indicating that the terminal device reports the BSR of the one LCG according to the first format when a service type corresponding to the one LCG is the first service type, and the terminal device reports the BSR of the one LCG according to the second format when the service type corresponding to the LCG is not the first service type.

Optionally, the number of BSRs that can be carried in the first format is different from that can be carried in the second format.

Optionally, the first format is a format for reporting only the BSR of the one LCG, and the second format is a format for reporting a BSR including at least the BSR of the one LCG.

Optionally, the transceiver unit 520 is specifically configured to: send a Radio Resource Control (RRC) signaling to the terminal device, and the RRC signaling includes the indication information.

It should be noted that the generating unit 510 may be implemented by a processor, and the transceiving unit 520 may be implemented by a transceiver. As shown in FIG. 10, a network device 600 may include a processor 610, a transceiver 620, and a memory 630. The memory 630 may be configured for storing indication information, or may be configured for storing codes, instructions, etc., executed by the processor 610. The various components in the network device 600 are connected by a bus system. The bus system includes a power bus, a control bus and a status signal bus in addition to a data bus.

The network device 600 shown in FIG. 10 may implement the various processes implemented by the network device in the method implementation of FIG. 2 described above. In order to avoid duplication, the details will not be repeated here. It should be noted that the method implementations in implementations of the present disclosure may be applied to a processor or implemented by the processor.

In the implementation process, each act of the method implementations in the implementations of the present disclosure may be completed by an integrated logic circuit of hardware in the processor or an instruction in the form of software. More specifically, the acts of the method disclosed in connection with the implementations of the present disclosure may be directly embodied as completion through the execution of a hardware decoding processor or completion through the execution in the combination of hardware and software modules in the decoding processor. Software modules may be located in a typical storage medium in the art, such as, a random access memory (RAM), a flash memory, a read-only memory, a programmable read-only memory, an electrical erasable programmable memory, or a register. The storage medium is located in the memory, and the processor reads information in the memory and completes the actions of the above method in combination with its hardware.

Herein, the processor may be an integrated circuit chip with a capability for processing signals, and may implement various methods, acts and logic block diagrams disclosed in the implementations of the present disclosure. For example, the above processor may be a general purpose processor, a digital signal processor (DSP), an application specific integrated circuit (ASIC), a field programmable gate array (FPGA) or another programmable logic device, a transistor logic device, or a discrete hardware component, or the like. Furthermore, the general purpose processor may be a microprocessor or the processor may be any conventional processor or the like.

In addition, the memory in implementations of the present disclosure may be a transitory memory or non-transitory memory, or may include both the transitory memory and the non-transitory memory. The non-transitory memory may be a read-only memory (ROM), a programmable ROM (PROM), an erasable PROM (EPROM), an electrically erasable EPROM (EEPROM), or a flash memory. The transitory memory may be a Random Access Memory (RAM) which serves as an external cache. It should be understood that, the foregoing memory is an example for illustration and should not be construed as limiting. For example, optionally, the memory in the implementations of the present disclosure may be a Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), Direct Rambus RAM (DR RAM), or the like. That is, memories in the systems and methods described herein are intended to include, but are not limited to, these and any other suitable types of memories.

Finally, it should be noted that the terms used in the implementations of the present disclosure and the appended claims are for the purpose of describing specific implementations only and are not intended to limit the implementations of the present disclosure.

For example, the singular forms “a”, “said”, and “the” used in the implementations of the present disclosure and the appended claims are also intended to include the plural forms unless the context clearly indicates other meanings.

For another example, depending on the context, the word “when” as used herein may be interpreted as “if” or “whether” or “while” or “in response to a determination of/that” or “in response to a detection of/that”. Similarly, depending on the context, the phrase “if determined” or “if detected (a stated condition or event)” may be interpreted as “when . . . is determined” or “in response to a determination” or “when (stated condition or event) is detected” or “in response to a detection of (stated condition or event)”.

Those of ordinary skill in the art will recognize that the example elements and algorithm acts described in combination with the implementations disclosed herein may be implemented in electronic hardware, or a combination of computer software and electronic hardware. Whether these functions are implemented in hardware or software depends on the specific application and design constraints of the technical solution. One skilled in the art may use different methods to implement the described functions for each particular application, but such implementation should not be considered to be beyond the scope of implementations of the present disclosure.

Those skilled in the art may clearly understand that for convenience and conciseness of description, the specific working processes of the systems, apparatuses and units described above may refer to the corresponding processes in the method implementations and will not be described here.

In several implementations provided by the present disclosure, it should be understood that the disclosed systems, apparatuses and methods may be implemented in other ways. For example, the apparatus implementations described above are only illustrative, for example, the division of the units is only a logical function division, and there may be other division modes in actual implementation, for example, multiple units or components may be combined or integrated into another system, or some features may be ignored or not executed. On the other hand, the mutual coupling or direct coupling or communication connection shown or discussed may be indirect coupling or communication connection through some interface, apparatus or unit, and may be in electrical, mechanical or other forms.

The unit described as a separate component may or may not be physically separated, and the component shown as a unit may or may not be a physical unit, i.e., it may be located in one place or may be distributed over multiple network units. Parts or all of the units may be selected according to actual needs to achieve the purpose of the implementations of the present disclosure.

In addition, various functional units in the implementations of the present disclosure may be integrated in one processing unit, or various units may be presented separately in a physical way, or two or more units may be integrated in one unit.

The function units may be stored in a computer readable storage medium if realized in a form of software functional units and sold or used as a separate product. Based on this understanding, the technical solutions of the implementations of the present disclosure, in essence, or the part contributing to the related art, or the part of the technical solutions, may be embodied in the form of a software product stored in a storage medium, including several instructions for causing a computer device (which may be a personal computer, a server, or a network device, etc.) to perform all or parts of the acts of the methods described in various implementations of the present disclosure. The aforementioned storage medium includes a medium capable of storing program codes, such as, a U disk, a mobile hard disk, a read-only memory (ROM), a magnetic disk or an optical disk, etc.

What are described above are merely the specific implementations of the implementations of the present disclosure, but the protection scope of the implementations of the present disclosure is not limited thereto. Any variation or substitution that may be easily conceived by a person skilled in the art within the technical scope disclosed by the implementations of the present disclosure shall be included within the protection scope of the implementations of the present disclosure. Therefore, the scope of protection of the implementations of the present disclosure should be subject to the scope of protection of the claims.

1. A method for transmitting data, comprising:
determining, by a terminal device, a reporting format of a buffer status report (BSR) of one Logical Channel Group (LCG) when the terminal device has only the one LCG with data to be transmitted, wherein the reporting format is a first format or a second format, and the first format is different from the second format; and
reporting, by the terminal device, the BSR of the one LCG according to the reporting format of the BSR of the one LCG.

2. The method of claim 1, wherein determining the reporting format of the BSR of the one LCG comprises:
determining, by the terminal device, the BSR of the one LCG according to a data amount of the one LCG or a service type corresponding to the one LCG or both.

3. The method of claim 1, wherein the method further comprises, before determining the reporting format of the BSR of the one LCG:
receiving, by the terminal device, indication information sent by a network device, wherein the indication information indicates that the terminal device reports the BSR of the one LCG according to the first format or the second format when the terminal device has only the one LCG with data to be transmitted; wherein
the reporting format of the BSR of the one LCG is determined according to the indication information.

4. The method of claim 3, wherein the indication information comprises a threshold value, the method further comprising:
causing the terminal device to report the BSR of the one LCG in the first format or the second format, depending on whether a data amount of the data to be transmitted in the one LCG is (1) less than or equal to the threshold value or (2) greater than the threshold value.

5. The method of claim 3, wherein the indication information comprises a first service type, the method further comprising:
causing the terminal device to report the BSR of the one LCG in the first format or the second format, depending on whether a service type that corresponds to the one LCG is the first service type or not.

6. The method of claim 1, wherein the number of BSRs that can be carried in the first format is different from that can be carried in the second format.

7. The method of claim 6, wherein the first format is a format reserved for a report that includes only the BSR of the one LCG, and the second format is a format reserved for a report that includes a BSR comprising at least the BSR of the one LCG.

8. The method of claim 3, further comprising:
receiving, by the terminal device, a Radio Resource Control (RRC) signaling that comprises the indication information.

9-15. (canceled)

16. A terminal device, comprising:
a processor, configured to determine a reporting format of a buffer status report (BSR) of one Logical Channel Group (LCG) when the terminal device has only the one LCG with data to be transmitted, wherein the reporting format is a first format or a second format, the first format and the second format are different; and
a transceiver, configured to report the BSR of the one LCG according to the reporting format of the BSR of the one LCG.

17. The terminal device of claim 16, wherein the processor is specifically configured to:
determine the BSR of the one LCG according to a data amount of the one LCG or a service type corresponding to the one LCG or both.

18. The terminal device of claim 16, wherein the transceiver is further configured to:
receive indication information sent by the network device before the processor determines the reporting format of the BSR of the one LCG, wherein the indication information indicates that the terminal device reports the BSR of the one LCG according to the first format or the second format when the terminal device has only the one LCG with data to be transmitted;
wherein the processor is specifically configured to:
determine the reporting format of the BSR of the one LGG according to the indication information.

19. The terminal device of claim 18, wherein the indication information comprises a threshold value, causing the terminal device to report the BSR of the one LCG in the first format or the second format, depending on whether a data amount of the data to be transmitted in the one LCG is (1) less than or equal to the threshold value or (2) greater than the threshold value.

20. The terminal device of claim 18, wherein the indication information comprises a first service type, causing the terminal device to report the BSR of the one LCG in the first format or the second format, depending on whether a service type that corresponds to the one LCG is the first service type or not.

21. The terminal device of claim 16, wherein the number of BSRs that can be carried in the first format is different from that can be carried in the second format.

22. The terminal device of claim 21, wherein the first format is a format for reporting only the BSR of the one LCG, and the second format is a format for reporting a BSR comprising at least the BSR of the one LCG.

23. The terminal device of claim 18, wherein the transceiver is specifically configured to:
receive a Radio Resource Control (RRC) signaling sent by the network device, wherein the RRC signaling comprises the indication information.

24. A network device, comprising:
a processor, configured to generate indication information, wherein the indication information is configured for a terminal device to determine a reporting format of a buffer status report (BSR) of one Logical Channel Group (LCG) when the terminal device has only the one LCG with data to be transmitted, the reporting format is a first format or a second format, the first format and the second format are different; and
a transceiver, configured to send the indication information to the terminal device.

25. The network device of claim 24, wherein the indication information indicates that the terminal device reports the BSR of one LCG according to the first format or the second format when the terminal device has only the one LCG with data to be transmitted.

26. The network device of claim 24, wherein the indication information comprises a threshold value, causing the terminal device to report the BSR of the one LCG in the first format or the second format, depending on whether a data amount of the data to be transmitted in the one LCG is (1) less than or equal to the threshold value or (2) greater than the threshold value.

27. The network device of claim 24, wherein the indication information comprises a first service type, causing the terminal device to report the BSR of the one LCG in the first format or the second format, depending on whether a service type that corresponds to the one LCG is the first service type or not.

28-30. (canceled)
